(19) United States
(12) Patent Application Publication
(10) Pub. No.: US 2015/0220884 A1
(43) Pub. Date: Aug. 6, 2015

(54) CANDIDATE OUTREACH FOR EVENT USING MATCHING ALGORITHM

(71) Applicant: Victor Louis Kabdebon, Sunnyvale, CA (US)

(72) Inventor: Victor Louis Kabdebon, Sunnyvale, CA (US)

(21) Appl. No.: 14/169,858

(22) Filed: Jan. 31, 2014

(51) Int. Cl. G06Q 10/10

(52) U.S. Cl. CPC G06Q 10/1053

(57) ABSTRACT

Methods and systems of candidate outreach for a recruitment event using a matching algorithm are described. According to various embodiments, a plurality of recruiters can be registered for a recruiting event, and each recruiter can be registered in association with at least one set of profile characteristic preferences. A plurality of candidates can be registered for the recruiting event, and each candidate can have profile characteristics. One of the candidates can be matched with one of the recruiters based on a comparison of the profile characteristics of the matched candidate with the profile characteristic preferences of the matched recruiter. An indication that the matched recruiter is interested in meeting the matched candidate at the recruiting event can be provided to the matched candidate on a computing device of the matched candidate.

### TECHNICAL FIELD

The present application relates generally to data processing systems and, in one specific example, to methods and systems of candidate outreach for recruitment events using a matching algorithm.

### BACKGROUND

Career fairs and other recruiting events suffer from several deficiencies. For example, recruiters can often miss a lot of suitable candidates. Additionally, the candidates often lack knowledge about the organizations the recruiters represent, as well as knowledge about which recruiters might be interested in them. Furthermore, candidates typically must provide the same introduction every time they go up to a recruiter at the event. This process is extremely inefficient, resulting in wasted time and missed opportunities.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIG. 1 illustrates a candidate outreach system, in accordance with an example embodiment;

FIG. 2 illustrates a table of recruiter registration information for a recruiting event, in accordance with an example embodiment;

FIG. 3 illustrates a table of candidate registration information for a recruiting event, in accordance with an example embodiment;

FIG. 4 illustrates a table of candidate scoring information for a recruiting event, in accordance with an example embodiment;

FIG. 5 illustrates an indication being provided to a candidate on a mobile device that a recruiter is interested in meeting the candidate at a recruiting event, in accordance with an example embodiment;

FIG. 6 illustrates a table of bidding information for a recruiting event, in accordance with an example embodiment;

FIG. 7 illustrates another table of bidding information, in accordance with an example embodiment;

FIG. 8 is a flowchart illustrating a method of performing candidate outreach for a recruiting event, in accordance with an example embodiment;

FIG. 9 is a flowchart illustrating a method of matching candidates with recruiters, in accordance with an example embodiment;

FIG. 10 is a flowchart illustrating another method of matching candidates with recruiters, in accordance with an example embodiment;

FIG. 11 is a block diagram illustrating a mobile device, in accordance with an example embodiments; and

FIG. 12 is a block diagram of an example computer system on which methodologies described herein may be executed, in accordance with an example embodiment.

### DETAILED DESCRIPTION

Example methods and systems of candidate outreach for recruitment events using a matching algorithm are described. In the following description, for purposes of explanation, numerous specific details are set forth in order to provide a thorough understanding of example embodiments. It will be evident, however, to one skilled in the art that the present embodiments may be practiced without these specific details.

The present disclosure provides techniques that enable recruiters to pull candidates to them during a recruiting event via indications provided to computing devices of the candidates. An organizer of a recruiting event can register the recruiting event and invite recruiters to the event via an online service (e.g., Linkedln®). The recruiters can register for the recruiting event and create profile characteristic preferences for the positions for which they would like to recruit candidates at the recruiting event via the online service. Each set of preferences for a position indicates the preferred characteristics the recruiter is seeking in candidates for the position. Candidates can register for the recruiting event via the online service and provide their profile characteristics, such as information about their education, skills, experience, previous employment, languages, age, geographic residence, and so on. A matching algorithm can be employed to match the registered candidates with the registered recruiters based on how closely the profile characteristics of the candidates match the profile characteristic preferences of the recruiters. Candidates that have been matched with recruiters can be provided a notification on their computing device to inform them of which recruiters would be interested in meeting with them. This notification can be provided during the event to provide an accurate, effective, and efficient candidate outreach process.

In some embodiments, a method comprises registering a plurality of recruiters for a recruiting event. Each recruiter can be registered in association with at least one set of profile characteristic preferences. A plurality of candidates can also be registered for the recruiting event, with each candidate having profile characteristics. One of the candidates can be matched with one of the recruiters based on a comparison of the profile characteristics of the matched candidate with profile characteristic preferences of the matched recruiter. An indication can be provided to the matched candidate on a computing device of the matched candidate that the matched recruiter is interested in meeting the matched candidate at the recruiting event.

In some embodiments, the profile characteristic preferences comprise at least one preference for education, skills, experience, previous employment, languages, age, or geographic residence, and the profile characteristics of each candidate comprise at least one of education, skills, experience, previous employment, languages, age, or geographic residence.

In some embodiments, matching one of the candidates with one of the recruiters comprises determining scores for the candidates based on the comparison of the profile characteristics of the matched candidate with the at least one set of profile characteristic preferences of the matched recruiter, determining a ranking of the candidates based on their corresponding scores, causing at least a portion of the ranking of candidates to be displayed to the recruiters, receiving bids on the candidates from the recruiters, and determining the matched candidate based on the bids. In some embodiments, matching one of the candidates with one of the recruiters comprises receiving bids from the recruiters, with each bid corresponding to a position or a set of one or more profile characteristic preferences, determining scores for the candidates based on the comparison of the profile characteristics of the candidates with the at least one set of profile characteristic preferences of the recruiters, and determining the matched candidate based on the scores and the bids.

In some embodiments, the computing device is a mobile device, and providing the indication to the matched candidate on the computing device comprises one of sending a text message to the computing device, sending a push notification to an application on the computing device, and sending an e-mail message to an e-mail account of the matched candidate. In some embodiments, the mobile device comprises a smart phone or a tablet computer.

In some embodiments, the indication comprises a prompting for the candidate to provide either positive or negative feedback as to whether the candidate would like to meet with the recruiter at the recruiting event. The method may further comprise, in response to not receiving positive feedback as to whether the candidate would like to meet with the recruiter at the recruiting event, matching another one of the candidates with the one of the recruiters based on a comparison of the profile characteristics of the other matched candidate with the at least one set of profile characteristic preferences of the matched recruiter. Another indication can be provided to the other matched candidate on a computing device of the other matched candidate that the matched recruiter is interested in meeting the other matched candidate at the recruiting event.

In some embodiments, the method further comprises receiving the profile characteristics for each candidate from each candidate entering the corresponding profile characteristics. In some embodiments, the method further comprises retrieving the profile characteristics for each candidate from at least one database of a social networking website or an employment website.

In some embodiments, the method further comprises determining which of the candidates is at the recruiting event, wherein only candidates that have been determined to be at the recruiting event are considered for matching with the recruiters. In some embodiments, determining which of the candidates is at the recruiting event comprises using Global Positioning System (GPS) location detection, Wi-Fi positioning detection, or a self-reporting positioning application.

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions.

In the following description, for purposes of explanation, numerous specific details are set forth in order to provide a thorough understanding of the various aspects of different embodiments of the present invention. It will be evident, however, to one skilled in the art, that the present invention may be practiced without all of the specific details.

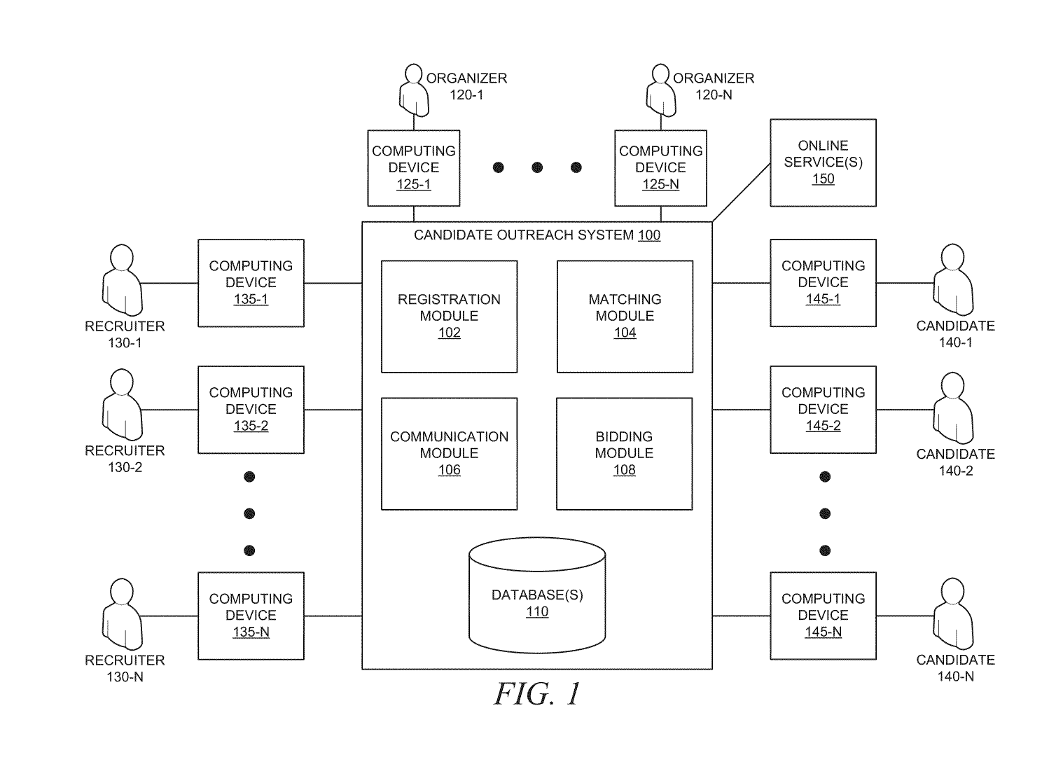

FIG. 1 illustrates a candidate outreach system 100, in accordance with an example embodiment. In some embodiments, the candidate outreach system 100 comprises a registration module 102, a matching module 104, a communication module 106, a bidding module 108, and one or more databases 110.

A plurality of organizers of recruiting events, such as organizers 120-1 to 120-N, can use the features of the candidate outreach system 100 disclosed herein via communication with the candidate outreach system 100 using their respective computing devices, such as computing devices 125-1 to 120-N. A plurality of recruiters, such as recruiters 130-1, 130-2, . . . , 130-N, can use the features of the candidate outreach system 100 disclosed herein via communication with the candidate outreach system 100 using their respective computing devices, such as computing devices 135-1, 135-2, . . . , 135-N. A plurality of candidates, such as candidates 140-1, 140-2, . . . , 140-N, can use the features of the candidate outreach system 100 disclosed herein via communication with the candidate outreach system 100 using their respective computing devices, such as computing devices 145-1, 145-2, . . . , 145-N. The computing devices disclosed herein can include mobile devices, including, but not limited to, smart phones and tablet computers. The computing devices disclosed herein can also include non-mobile devices, including but not limited to, desktop computers. Other types of computing devices are also within the scope of the present disclosure.

Communication between the candidate outreach system 100 and the computing devices, as well as communication between the components (e.g., modules and database(s)) of the candidate outreach system 100, can be achieved via one or more networks. The network(s) may include any network that enables communication between or among machines, databases, and devices. Accordingly, the network(s) may include a wired network, a wireless network (e.g., a mobile or cellular network), or any suitable combination thereof. The network(s) may include one or more portions that constitute a private network, a public network (e.g., the Internet), or any suitable combination thereof. Other configurations are also within the scope of the present disclosure.

Furthermore, although the components (e.g., modules and database(s)) of candidate outreach system 100 are shown in FIG. 1 as residing on a system (e.g., hardware) that is separate and distinct from the computing devices of the organizers, recruiters, and candidates, it is contemplated that any combination of one or more of the components of the candidate outreach system 100, or portions thereof, may also reside on any of those computing devices. For example, features of the candidate outreach system 100 may be implemented as a mobile application that can be installed on the computing devices of the organizers, recruiters, or candidates.

In some embodiments, the registration module 102 is configured to create and register recruiting events. An organizer of a recruiting event, such as a university administrator organizing a career fair on the university campus, can register the recruiting event with the candidate outreach system 100 using the registration module 102. The registration module 102 may receive information about the recruiting event from the organizer. This event information may include, but is not limited to, the date of the event, the star time of the event, the end time of the event, the location of the event, a restriction on the maximum number of recruiters that may register for the event, and a restriction on the maximum number of candidates that may register fort the event. Additionally, the organizer can identify recruiters to invite to the recruiting event using the registration module 102, such as by providing the name and contact information of the intended recruiter invitees to the registration module 102. All of this information provided by the organizer can be stored in database(s) 110 for subsequent access and retrieval.

In some embodiments, the registration module 102 is configured to register recruiters for the recruiting event. A recruiter can be any person, company, organization, or entity that is interested in recruiting a candidate for a position of employment with the recruiter. Recruiters, such as recruiters 130-1, 130-2, . . . , 130-N, can register for a specific recruiting event using registration module 102.

The registration module 102 can receive profile characteristic preferences from the recruiters. The profile characteristic preferences are preferences that a recruiter has regarding characteristics of candidates with which the recruiter has an interest in meeting at the recruiting event. Examples of such characteristics include, but are not limited to, education (e.g., classes taken, type of degree, etc.), skills, experience (e.g., a minimum level of work experience), previous employment, languages, age, and geographic residence. Other characteristics are also within the scope of the present disclosure. The registration module 102 can register the profile characteristic preferences in association with the corresponding recruiter. In some embodiments, recruiters can associate different sets of profile characteristic preferences with different positions. All of this information provided by the recruiter can be stored in database(s) 110 for subsequent access and retrieval.

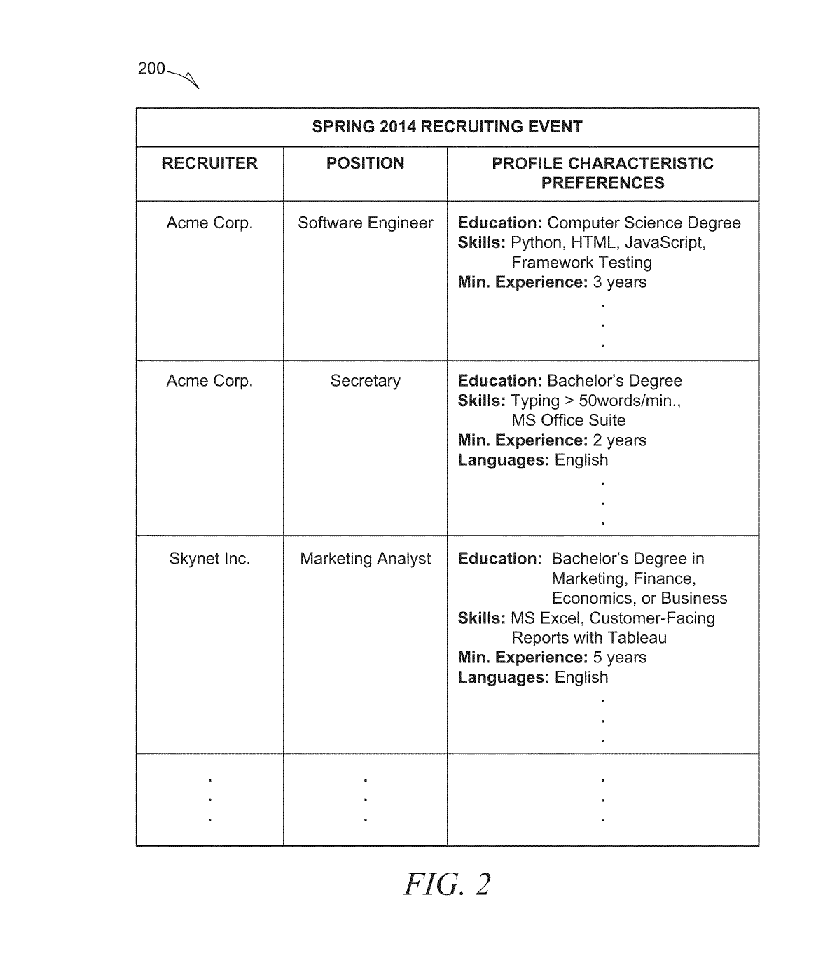

FIG. 2 illustrates a table 200 of recruiter registration information for a recruiting event (e.g., “SPRING 2014 RECRUITING EVENT”), in accordance with an example embodiment. As seen in FIG. 2, multiple recruiters (e.g., Acme Corp., Skynet Inc., etc.) can register for the same recruiting event. Additionally, each recruiter can register multiple sets of profile characteristic preferences. For example, FIG. 2 shows two sets of profile characteristic preferences that Acme Corp. has registered for the recruiting event, one for a “Software Engineer” position and another for a “Secretary” position. Each set of profile characteristic preferences indicates a set of one or more qualities (e.g., education, skills, minimum level of experience, languages spoken, etc.) that the corresponding recruiter is looking for in a candidate for a particular position, thereby indicating what type of candidate the recruiter would like to meet with at the recruiting event.

In addition to the information discussed above, recruiters can also provide and register additional information with the candidate outreach system 100 via the registration module 102. Such additional information may include, but is not limited to, location information regarding where the recruiter will be at the recruiting event (e.g., a booth number), as well as a custom message that may be used in invitational messages to the candidates who are matched with the recruiter for meeting at the recruiting event.

Referring back to FIG. 1, in some embodiments, the registration module 102 is configured to register candidates for the recruiting event. A candidate can be any person that is interested in attending the recruiting event to meet with recruiters. Candidates, such as candidates 140-1, 140-2, . . . , 140-N, can register for a specific recruiting event using the registration module 102. The registration module 102 can receive candidate profile characteristics for each candidate registered for the recruiting event. The candidate profile characteristics are characteristics that can be used to match candidates with recruiters based on a comparison with the profile characteristic preferences indicated by the recruiter. Accordingly, the types of candidate profile characteristics may correspond with the types of profile characteristic preferences. For example, the candidate profile characteristics may include, but are not limited to, education (e.g., classes taken, type of degree, etc.), skills, experience (e.g., a minimum level of work experience), previous employment, languages, age, and geographic residence. Other characteristics are also within the scope of the present disclosure. Registration module 102 can register the candidate profile characteristics in association with the corresponding candidate. All of this candidate registration information can be stored in database(s) 110 for subsequent access and retrieval.

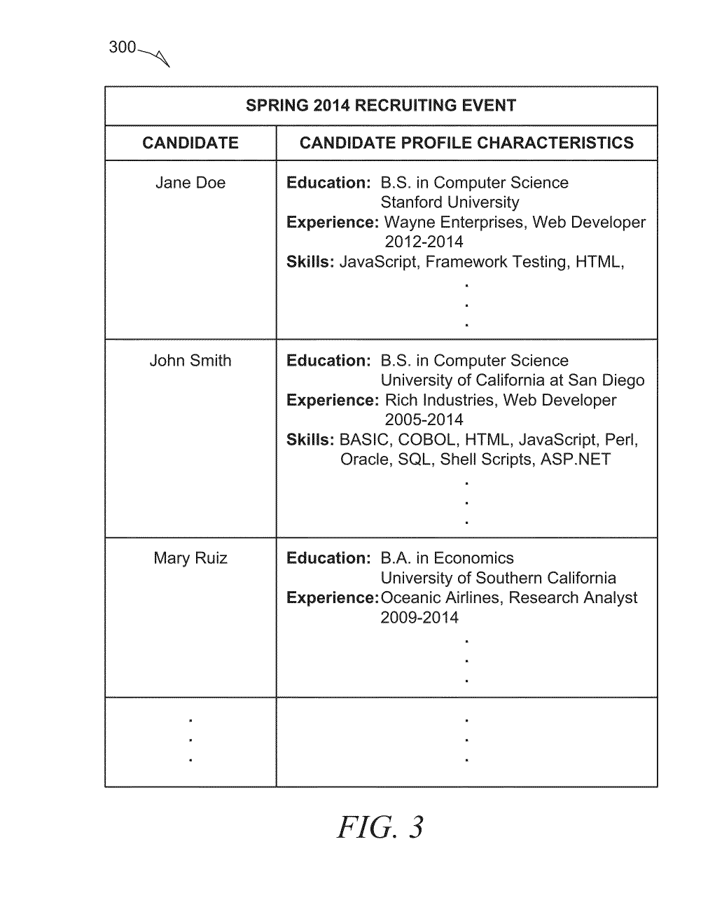

FIG. 3 illustrates a table 200 of candidate registration information for a recruiting event (e.g., “SPRING 2014 RECRUITING EVENT”), in accordance with an example embodiment. As seen in FIG. 3, multiple candidates (e.g., Jane Doe, John Smith, Mary Ruiz, etc.) can register for the same recruiting event. Additionally, each candidate can register a set of one or more candidate profile characteristics.

It is contemplated that the candidate profile characteristics can be obtained in a variety of ways. In some embodiments, the registration module 102 can receive the candidate profile characteristics of a candidate via selections or inputs provided by candidate using graphical user interface elements (e.g., text fields, drop-down lists, check boxes, etc.) during a registration process implemented by the registration module 102. In some embodiments, registration module 102 can receive the candidate profile characteristics of a candidate from a stored resume or profile of the candidate. The resume or profile of the candidate may be stored in the database(s) 110 of the candidate outreach system 100 or may be retrieved from one or more external online services 150, such as a social networking website (e.g., a candidate's profile on Linkedln®) or an employment website (e.g., Monster.com®). For example, the registration module 102 may access the externally stored resume or profile, and parse it to extract the relevant candidate profile characteristics. Other techniques for obtaining the candidate profile characteristics are also within the scope of the present disclosure.

Referring back to FIG. 1, in some embodiments, the matching module 104 is configured to match at least one of the candidates (e.g., candidates 140-1, 140-2, . . . , 140-N) with at least one of the recruiters (e.g., recruiters 130-1, 130-2, . . . , 130-N) based on a comparison of the profile characteristics of the candidates with the profile characteristic preferences of the recruiters. The matching module 104 may determine a score for each candidate based on an analysis of how closely the candidate profile characteristics of the candidate match the profile characteristic preferences of a recruiter.

In some embodiments, different types of profile characteristics may be weighted differently for scoring each candidate. In some embodiments, recruiters may provide indications to the registration module 102 regarding the weights to be attributed to each profile characteristic. These weights may then be used by the matching module 104 in determining the scores for the candidates. For example, a first recruiter may value education and skills over the amount of experience a candidate has, whereas a second recruiter may value the amount of experience a candidate has over education and skills. Accordingly, the first recruiter may provide instruction to the candidate outreach system 100 to weight the matching of education and skills more than the matching of the amount of experience when determining the scores for candidates, while the second recruiter may provide instruction to the candidate outreach system 100 to weight the matching of the amount of experience more than the matching of education and skills. As a result, even if the first recruiter and the second recruiter have identical profile characteristic preferences for a particular position, the same candidate may have a different score for the first recruiter than for the second recruiter because of the different in weighting priorities set by the different recruiters.

Additionally, the same recruiter may set different weights for the same profile characteristic preference across different positions. For example, the first recruiter may value education and skills over the amount of experience a candidate has when determining scores for candidates for a software engineer position. However, that same first recruiter may value the amount of experience a candidate has over education and skills when determining scores for candidates for a secretary position. Accordingly, the first recruiter may provide instruction to the candidate outreach system 100 to weight the matching of education and skills one way when determining the scores for candidates for the software engineer position, while providing instruction to the candidate outreach system 100 to weight the matching of education and skills another way when determining the scores for candidates for the secretary position.

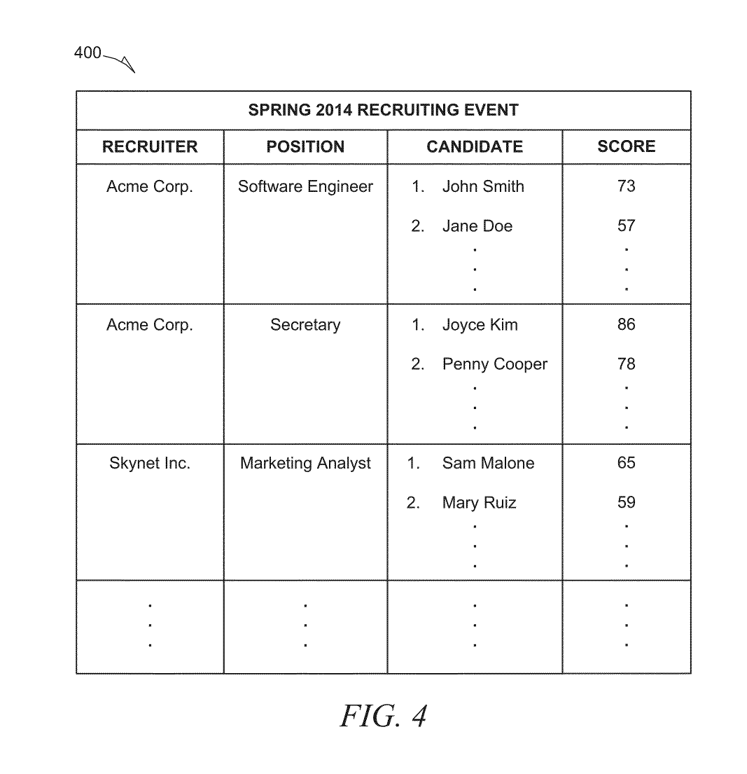

FIG. 4 illustrates a table 400 of candidate scoring information for a recruiting event, in accordance with an example embodiment. As seen in FIG. 4, for each position being recruited for by a recruiter, the candidates can be scored based on the scoring techniques discussed herein. The candidates can then be ranked based on their corresponding scores. For example, in FIG. 4, John Smith has then highest score (73) for the software engineer position with Acme Corp., Jane Doe has the second highest score (57) for the software engineer position with Acme Corp., and so on and so forth. The matching module 104 may select a predetermined number of the highest ranking candidates (e.g., the three highest ranking candidates) for matching with the recruiter for the corresponding position.

In some embodiments, the matching module 104 is configured to perform the matching of candidates with recruiters after the recruiting event has begun. In some embodiments, the matching module 104 is configured to determine which of the registered candidates is at the recruiting event, and to consider only those candidates that have been determined to be at the recruiting event for matching with the recruiters. In this respect, the matching module 104 may avoid scoring a candidate that is not attending the recruiting event and/or otherwise matching a candidate that is not attending the recruiting event with a recruiter, thereby increasing efficiency and reducing the risk of a recruiter and a candidate not being matched up due to preference being given to another candidate that is not even attending the recruiting event. It is contemplated that the determination of whether a candidate is at the recruiting event can be achieved in a variety of ways. In some embodiments, determining whether a candidates is at the recruiting event comprises determining the location of the candidate using GPS location detection of a mobile device associated with the candidate, Wi-Fi positioning detection of a mobile device associated with the candidate, or receiving information from a self-reporting positioning application (e.g., applications that enable a user to “check-in”, such as Foursquare® and Facebook®) on a mobile device associated with the candidate. The matching module 104 can then determine whether the location of the candidate falls within a predetermined geographic zone for the recruiting event. This geographic zone can include, but is not limited to, one or more specified rooms, and one or more specified buildings. In some embodiments, candidates can use one or more computing devices (e.g., a kiosk) set up at the location of the recruiting event for checking in to the recruiting event. It is contemplated that other techniques of determining which of the registered candidates is at the recruiting event are also within the scope of the present disclosure.

Referring back to FIG. 1, in some embodiments, the communication module 106 is configured to provide an indication to each matched candidate that the corresponding matched recruiter is interested in meeting the matched candidate at the recruiting event. The indication can be provided to a candidate in a variety of ways, including but not limited to, sending a text message to a computing device associated with the candidate, sending a push notification to an application on a computing device associated with the candidate, and sending an e-mail message to an e-mail account associated with the candidate. It is contemplated that other techniques of providing the indication to a candidate are also within the scope of the present disclosure.

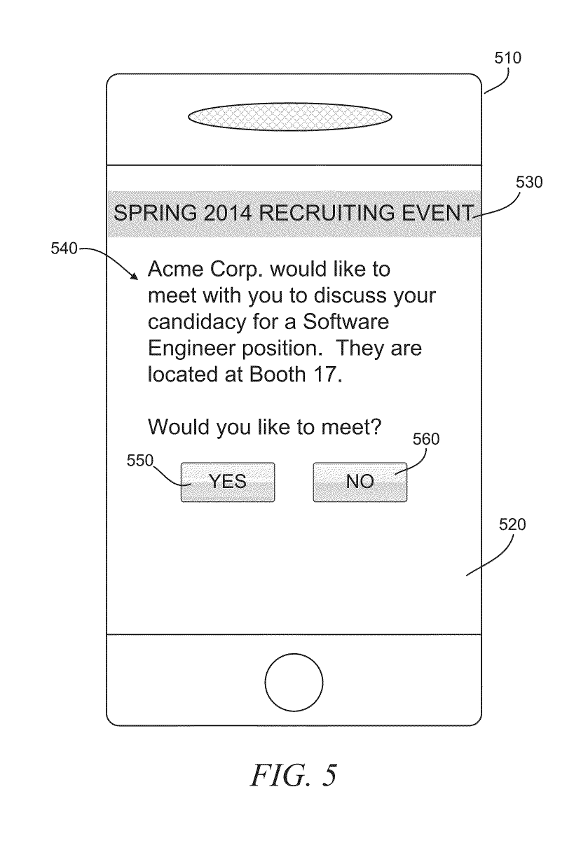

FIG. 5 illustrates an indication 540 being provided to a candidate on a mobile device 510 that a recruiter is interested in meeting the candidate at a recruiting event, in accordance with an example embodiment. In FIG. 5, the indication 540 is displayed on a display screen 520 of the mobile device 510. The indication 540 can include information indicating an identification of the recruiter (e.g., Acme Corp.), an identification of the corresponding position (e.g., Software Engineer), and an identification of the location of the recruiter (e.g., Booth 17). In some embodiments, an identification 530 of the recruiting event (e.g., “Spring 2014 Recruiting Event”) may be displayed as well.

Additionally, in some embodiments, the indication 540 also comprises a prompting for the candidate to provide either positive or negative feedback as to whether the candidate would like to meet with the recruiter at the recruiting event (e.g., “Would you like to meet?”). Positive and negative selectable graphical user interface elements 550 and 560, respectively, can be provided to enable the candidate viewing the indication 540 to provide feedback regarding the prompting, such as whether or not the candidate would like to meet with the recruiter during the recruiting event.

Referring back to FIG. 1, in some embodiments, the communication module 106 is configured to receive the feedback from the candidate. The matching module 104 can then use the received feedback for further processing. In some embodiments, if the feedback is positive, then the matching module 104 can automatically schedule a meeting for the candidate with the recruiter. For example, the matching module 104 can trigger the sending of a notification to the recruiter that the candidate would like to meet with the recruiter. In some embodiments, the matching module 104 can access a schedule of meeting times for the recruiter, determine an appropriate meeting time between the candidate and the recruiter, and provide notification of the determined meeting time to both the recruiter and the candidate.

In some embodiments, if the feedback is negative or if positive feedback is not received within a predetermined amount of time (e.g., within 30 minutes of the indication being provided to the candidate), then the matching module 104 can match another one of the candidates with the recruiter, such as by using the matching techniques discussed herein. The candidate that provided the negative feedback or that failed to provide the positive feedback within the predetermined amount of time can be removed from this subsequent consideration for matching with the recruiter, as this candidate is likely not interested in meeting with the recruiter. The communication module 106 can then provide another indication to the subsequently matched candidate that the recruiter is interested in meeting him or her at the recruiting event.

In some embodiments, the candidate outreach system 100 can inject competition between the recruiters in matching the candidates with the recruiters. The bidding module 108 can enable recruiters to place bids that can be used in matching candidates with recruiters. In some embodiments, the bidding module 108 issues a certain number of credits to each recruiter. Each recruiter can be issued the same number of credits. Alternatively, recruiters can be issued different number of credits based on any combination of one or more factors, including, but not limited to, how many credits the recruiter has purchased and the number of recruiting events the recruiter has attended or registered for in the past. Other factors for determining the number of credits to issue recruiters are also within the scope of the present disclosure.

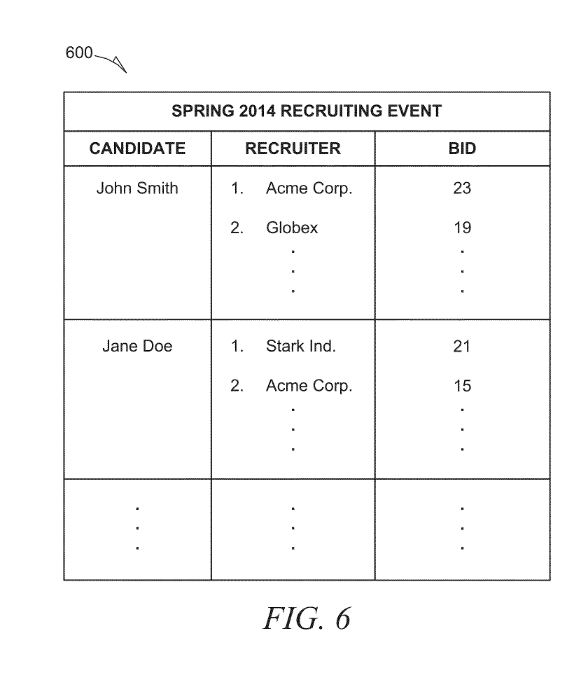

The recruiters can place bids on candidates using their credits. In some embodiments, the recruiters can place bids on specific candidates. For example, a list of candidates can be provided to a recruiter. The list may indicate how closely the profile characteristics of the candidates match the profile characteristic preferences of the recruiter, such as by including corresponding scores or otherwise indicating the ranking of the candidates. The recruiter may then use the credits to place a bid on one or more of the candidates via the bidding module 108. The matching module 104 may then use these bids in matching the candidates with the recruiters. For example, the matching module 104 may match a candidate with a predetermined number of the highest bidding recruiters for that candidate. FIG. 6 illustrates a table 600 of bidding information for a recruiting event, in accordance with an example embodiment. In FIG. 6, Acme Corp. and Globex have placed the two highest bids, 23 and 19 respectively, for candidate John Smith. In some embodiments, John Smith may then be matched with Acme Corp. and Globex, or any other number of the highest bidding recruiters.

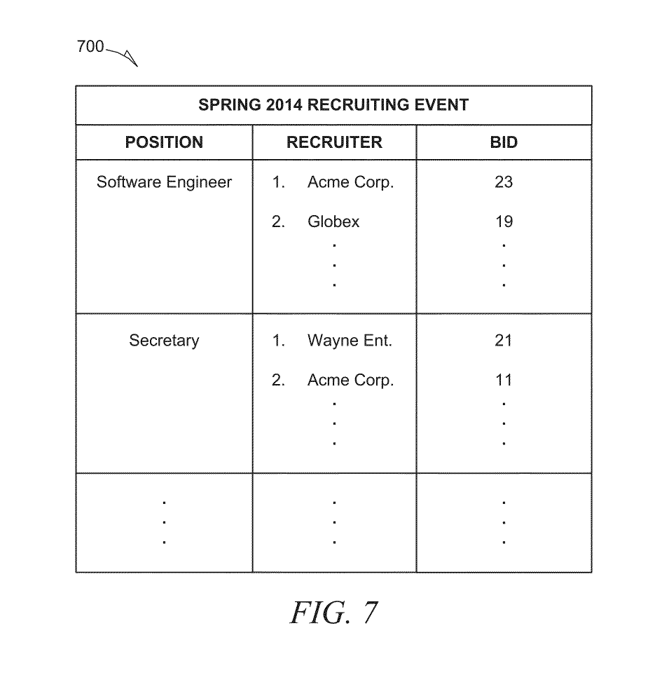

In some embodiments, the recruiters can place bids on a certain position for which they will be recruiting at the recruiting event. The matching module 104 may then use these bids in matching the candidates with the recruiters. For example, the matching module 104 may match a candidate with a predetermined number of the highest bidding recruiters for a position for which that candidate is determined to be a good match (e.g., if the candidate has a sufficiently high score for that position). FIG. 7 illustrates a table 700 of bidding information, in accordance with an example embodiment. In FIG. 7, Acme Corp. and Globex have placed the two highest bids, 23 and 19 respectively, for the position of software engineer. In some embodiments, a predetermined number of the highest ranking candidates for these positions may then be matched with Acme Corp. and Globex, or any other number of the highest bidding recruiters. In some embodiments, the recruiters may similarly place bids on their one or more sets of profile characteristic preferences. These bids may similarly be used to match the candidates with the recruiters.

Additional factors and considerations that can be taken into account in matching the candidates with recruiters include, but are not limited to, the duration of the recruiting event (which may be provided by the organizer of the recruiting event during registration), the availability or schedule of the recruiters (which may be provided by the recruiters during registration and updated during the recruiting event as candidates are matched with the recruiters and meetings are scheduled), a predefined amount of time for a meeting with a candidate (which may be provided by the recruiters during registration), and the availability or schedule of the candidates (which may be provided by the candidates during registration and updated during the recruiting event as candidates are matched with the recruiters and meetings are scheduled).

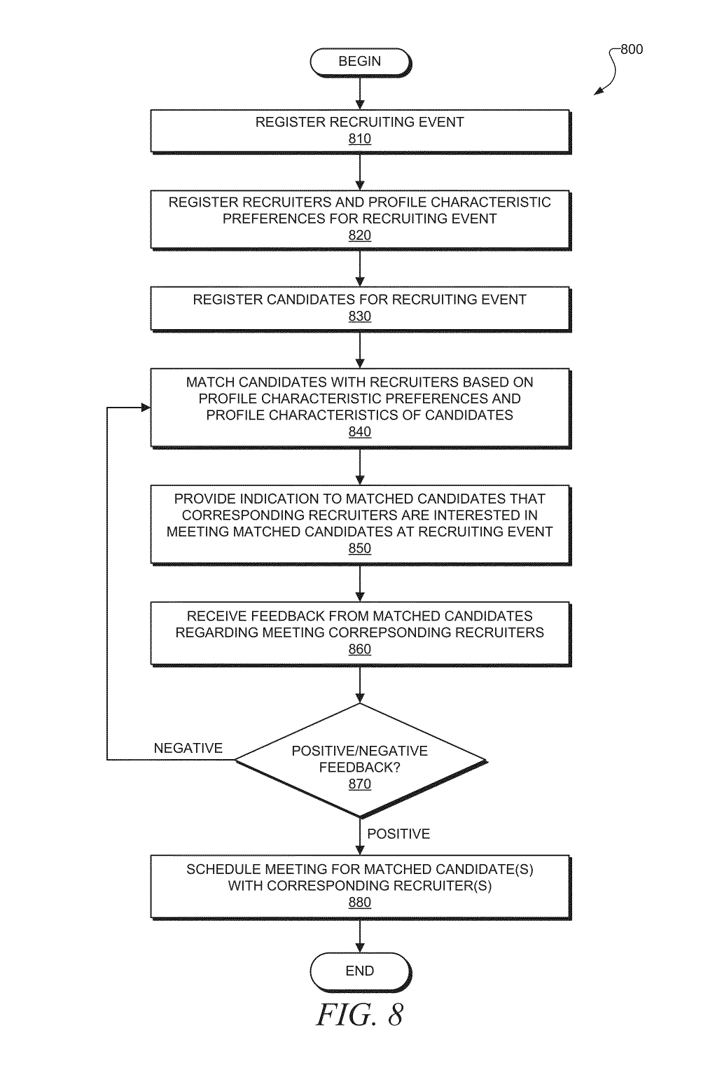

FIG. 8 is a flowchart illustrating a method 800 of performing candidate outreach for a recruiting event, in accordance with an example embodiment. It is contemplated that the operations of method 800 may be performed by a system or modules of a system (e.g., candidate outreach system 100 in FIG. 1). At operation 810, an organizer of a recruiting event can register the recruiting event with the candidate outreach system 100. At operation 820, recruiters can register for the recruiting event. The recruiters can also register one or more sets of profile characteristic preferences for the recruiting event. At operation 830, candidates can register for the recruiting event. Each candidate can have a corresponding set of one or more profile characteristics, which can be provided by the candidate during the registration process or subsequently retrieved from either an internal database or an external database (e.g., an external social networking website or an external employment website). At operation 840, candidates can be matched with recruiters based on a comparison of the corresponding profile characteristic preferences of the recruiters with the corresponding profile characteristics of the candidates. At operation 850, an indication that the matched recruiter(s) are interested in meeting with the matched candidate(s) at the recruiting event can be provided to the matched candidate(s). At operation 860, feedback can be received from the matched candidate(s) regarding the matched candidate(s) interest in meeting the matched recruiter(s). At operation 870, it can be determined whether positive or negative feedback has been received from the matched candidate(s). In some embodiments, the lack of receiving positive feedback within a predetermined amount of time may constitute negative feedback. If negative feedback is received (or if positive feedback is not received within a predetermined amount of time), then the method 80 repeats the matching operation at operation 840, this time removing the previously matched candidate(s) who provided the negative feedback (or lack of positive feedback) from consideration for matching. If positive feedback is received, then, at operation 880, a meeting can be scheduled for the matched candidate(s) with the corresponding matched recruiter(s). It is contemplated that the operations of method 800 may incorporate any of the other features disclosed herein.

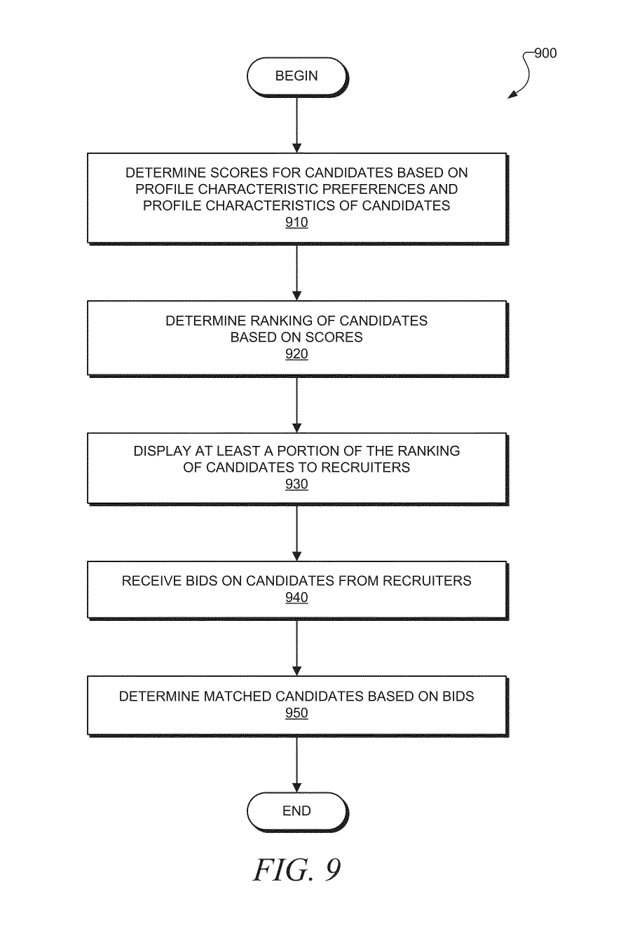

FIG. 9 is a flowchart illustrating a method 900 of matching candidates with recruiters, in accordance with an example embodiment. It is contemplated that the operations of method 900 may be performed by a system or modules of a system (e.g., candidate outreach system 100 in FIG. 1). At operation 910, scores can be determined for candidates based on a comparison of the profile characteristics of the candidates with the profile characteristic preferences of the recruiters. At operation 920, a ranking of the candidates can be determined based on the scores. At operation 930, at least a portion of the ranking of the candidates can be caused to be displayed to the recruiters. At operation 940, bids on the candidates can be received from the recruiters. At operation 950, matched candidates can be determined for the recruiters based on the bids. It is contemplated that the operations of method 900 may incorporate any of the other features disclosed herein.

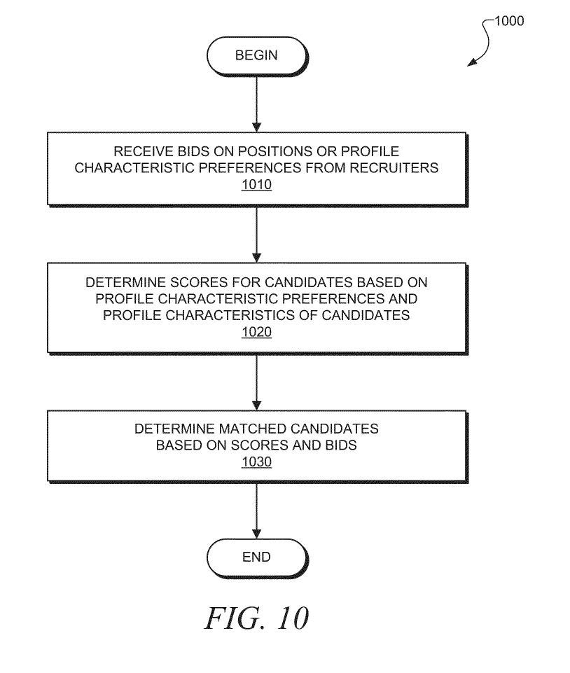

FIG. 10 is a flowchart illustrating a method 1000 of matching candidates with recruiters, in accordance with an example embodiment. It is contemplated that the operations of method 1000 may be performed by a system or modules of a system (e.g., candidate outreach system 100 in FIG. 1). At operation 1010, bids on positions or on sets of profile characteristic preferences can be received from recruiters. At operation 1020, scores can be determined for candidates based on a comparison of profile characteristics of the candidates with profile characteristic preferences of the recruiters. At operation 1030, matched candidates can be determined for the recruiters based on the scores and bids. It is contemplated that the operations of method 1000 may incorporate any of the other features disclosed herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules, engines, objects or devices that operate to perform one or more operations or functions. The modules, engines, objects and devices referred to herein may, in some example embodiments, comprise processor-implemented modules, engines, objects and/or devices.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

### Example Mobile Device

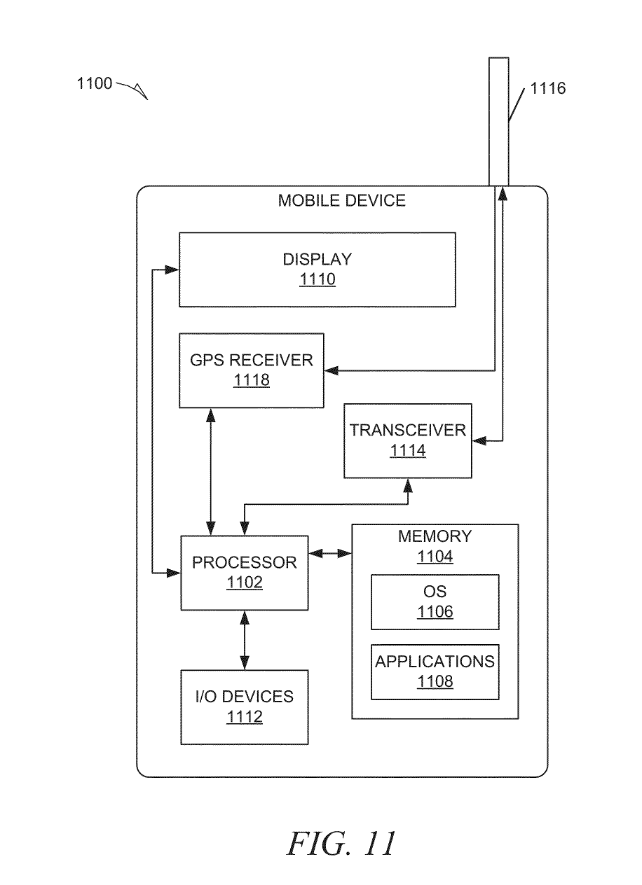

FIG. 11 is a block diagram illustrating a mobile device 1100, according to an example embodiment. The mobile device 1100 may include a processor 1102. The processor 1102 may be any of a variety of different types of commercially available processors 1102 suitable for mobile devices 1100 (for example, an XScale architecture microprocessor, a microprocessor without interlocked pipeline stages (MIPS) architecture processor, or another type of processor 1102). A memory 1104, such as a random access memory (RAM), a flash memory, or other type of memory, is typically accessible to the processor 1102. The memory 1104 may be adapted to store an operating system (OS) 1106, as well as application programs 1108, such as a mobile location enabled application that may provide LBSs to a user. The processor 1102 may be coupled, either directly or via appropriate intermediary hardware, to a display 1110 and to one or more input/output (I/O) devices 1112, such as a keypad, a touch panel sensor, a microphone, and the like. Similarly, in some embodiments, the processor 1102 may be coupled to a transceiver 1114 that interfaces with an antenna 1116. The transceiver 1114 may be configured to both transmit and receive cellular network signals, wireless data signals, or other types of signals via the antenna 1116, depending on the nature of the mobile device 1100. Further, in some configurations, a GPS receiver 1118 may also make use of the antenna 1116 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architetecture and Machine-Readable Medium

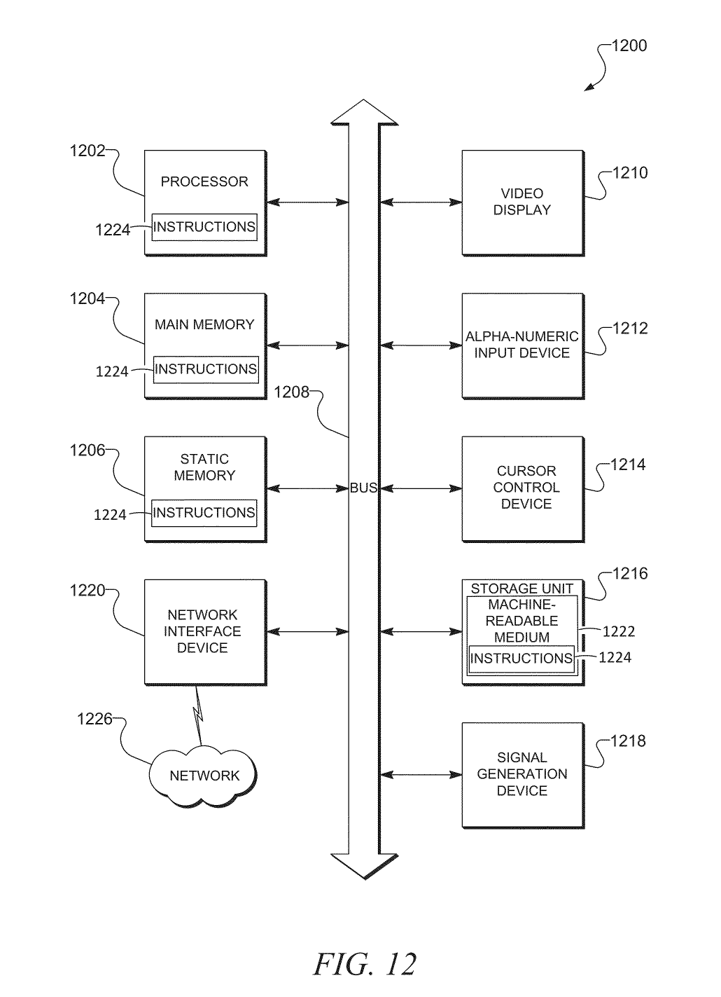

FIG. 12 is a block diagram of an example computer system 1200 on which methodologies described herein may be executed, in accordance with an example embodiment. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU) or both), a main memory 1204 and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard or a touch-sensitive display screen), a user interface (UI) navigation device 1214 (e.g., a mouse), a disk drive unit 1216, a signal generation device 1218 (e.g., a speaker) and a network interface device 1220.

### Machine-Readable Meidum

The disk drive unit 1216 includes a machine-readable medium 1222 on which is stored one or more sets of instructions and data structures (e.g., software) 1224 embodying or utilized by any one or more of the methodologies or functions described herein. The instructions 1224 may also reside, completely or at least partially, within the main memory 1204 and/or within the processor 1202 during execution thereof by the computer system 1200, the main memory 1204 and the processor 1202 also constituting machine-readable media.

While the machine-readable medium 1222 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1224 may further be transmitted or received over a communications network 1226 using a transmission medium. The instructions 1224 may be transmitted using the network interface device 1220 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
registering a plurality of recruiters for a recruiting event, each recruiter being registered in association with at least one set of profile characteristic preferences;
registering a plurality of candidates for the recruiting event, each candidate having profile characteristics;
matching, using a machine having a memory and at least one processor, one of the candidates with one of the recruiters based on a comparison of the profile characteristics of the matched candidate with the at least one set of profile characteristic preferences of the matched recruiter; and
providing an indication to the matched candidate on a computing device of the matched candidate that the matched recruiter is interested in meeting the matched candidate at the recruiting event.

2. The method of claim 1, wherein:
the at least one set of profile characteristic preferences comprise at least one preference for education, skills, experience, previous employment, languages, age, or geographic residence; and
the profile characteristics of each candidate comprises at least one of education, skills, experience, previous employment, languages, age, or geographic residence.

3. The method of claim 1, wherein matching one of the candidates with one of the recruiters comprises:
determining scores for the candidates based on the comparison of the profile characteristics of the matched candidate with the at least one set of profile characteristic preferences of the matched recruiter;
determining a ranking of the candidates based on their corresponding scores;
causing at least a portion of the ranking of candidates to be displayed to the recruiters;
receiving bids on the candidates from the recruiters; and
determining the matched candidate based on the bids.

4. The method of claim 1, wherein matching one of the candidates with one of the recruiters comprises:
receiving bids from the recruiters, each bid corresponding to a position or a set of one or more profile characteristic preferences;
determining scores for the candidates based on the comparison of the profile characteristics of the candidates with the at least one set of profile characteristic preferences of the recruiters; and
determining the matched candidate based on the scores and the bids.

5. The method of claim 1, wherein the computing device is a mobile device, and providing the indication to the matched candidate on the computing device comprises one of sending a text message to the computing device, sending a push notification to an application on the computing device, and sending an e-mail message to an e-mail account of the matched candidate.

6. The method of claim 5, wherein the mobile device comprises a smart phone or a tablet computer.

7. The method of claim 1, wherein:
the indication comprises a prompting for the candidate to provide either positive or negative feedback as to whether the candidate would like to meet with the recruiter at the recruiting event; and
the method further comprises:
in response to not receiving positive feedback as to whether the candidate would like to meet with the recruiter at the recruiting event, matching another one of the candidates with the one of the recruiters based on a comparison of the profile characteristics of the other matched candidate with the at least one set of profile characteristic preferences of the matched recruiter; and
providing another indication to the other matched candidate on a computing device of the other matched candidate that the matched recruiter is interested in meeting the other matched candidate at the recruiting event.

8. The method of claim 1, further comprising receiving the profile characteristics for each candidate from each candidate entering the corresponding profile characteristics.

9. The method of claim 1, further comprising retrieving the profile characteristics for each candidate from at least one database of a social networking website or an employment website.

10. The method of claim 1, further comprising determining which of the candidates is at the recruiting event, wherein only candidates that have been determined to be at the recruiting event are considered for matching with the recruiters.

11. The method of claim 11, wherein determining which of the candidates is at the recruiting event comprises using Global Positioning System (GPS) location detection, Wi-Fi positioning detection, or a self-reporting positioning application.

12. A system comprising:
a machine having a memory and at least one processor;
a registration module configured to:
register a plurality of recruiters for a recruiting event, each recruiter being registered in association with at least one set of profile characteristic preferences; and
register a plurality of candidates for the recruiting event, each candidate having profile characteristics;
a matching module, executable by a machine having a memory and at least one processor, configured to match one of the candidates with one of the recruiters based on a comparison of the profile characteristics of the matched candidate with the at least one set of profile characteristic preferences of the matched recruiter; and
a communication module configured to provide an indication to the matched candidate on a computing device of the matched candidate that the matched recruiter is interested in meeting the matched candidate at the recruiting event.

13. The system of claim 12, wherein:
the at least one set of profile characteristic preferences comprise at least one preference for education, skills, experience, previous employment, languages, age, or geographic residence; and
the profile characteristics of each candidate comprises at least one of education, skills, experience, previous employment, languages, age, or geographic residence.

14. The system of claim 12, further comprising a bidding module configured to receive bids on the candidates from the recruiters, and the matching module is further configured to:
determine scores for the candidates based on the comparison of the profile characteristics of the matched candidate with the at least one set of profile characteristic preferences of the matched recruiter;
determine a ranking of the candidates based on their corresponding scores;
cause at least a portion of the ranking of candidates to be displayed to the recruiters; and
determine the matched candidate based on the bids.

15. The system of claim 12, further comprising a bidding module configured to receive bids from the recruiters, each bid corresponding to a position or a set of one or more profile characteristic preferences, and the matching module is further configured to:
determine scores for the candidates based on the comparison of the profile characteristics of the candidates with the at least one set of profile characteristic preferences of the recruiters; and
determine the matched candidate based on the scores and the bids.

16. The system of claim 12, wherein:
the indication comprises a prompting for the candidate to provide either positive or negative feedback as to whether the candidate would like to meet with the recruiter at the recruiting event;
the matching module is further configured to, in response to not receiving positive feedback as to whether the candidate would like to meet with the recruiter at the recruiting event, match another one of the candidates with the one of the recruiters based on a comparison of the profile characteristics of the other matched candidate with the at least one set of profile characteristic preferences of the matched recruiter; and
the communication module is further configured to provide another indication to the other matched candidate on a computing device of the other matched candidate that the matched recruiter is interested in meeting the other matched candidate at the recruiting event.

17. The system of claim 12, wherein the registration module is further configured to receive the profile characteristics for each candidate from each candidate entering the corresponding profile characteristics.

18. The system of claim 12, wherein the registration module is further configured to retrieve the profile characteristics for each candidate from at least one database of a social networking website or an employment website.

19. The system of claim 12, wherein the matching module is further configured to determine which of the candidates is at the recruiting event, and to consider only candidates that have been determined to be at the recruiting event for matching with the recruiters.

20. A non-transitory machine-readable medium embodying a set of instructions that, when executed by a processor, cause the processor to perform operations, the operations comprising:
registering a plurality of recruiters for a recruiting event, each recruiter being registered in association with at least one set of profile characteristic preferences;
registering a plurality of candidates for the recruiting event, each candidate having profile characteristics;
matching one of the candidates with one of the recruiters based on a comparison of the profile characteristics of the matched candidate with the at least one set of profile characteristic preferences of the matched recruiter; and
providing an indication to the matched candidate on a computing device of the matched candidate that the matched recruiter is interested in meeting the matched candidate at the recruiting event.
